(19) United States
(12) Patent Application Publication
(10) Pub. No.: US 2023/0386445 A1
(43) Pub. Date: Nov. 30, 2023

(54) INFORMATION REPRODUCTION PROGRAM, INFORMATION REPRODUCTION METHOD, INFORMATION, PROCESSING DEVICE, AND DATA STRUCTURE

(71) Applicant: WASEDA UNIVERSITY, Tokyo (JP)

(72) Inventors: Hiroaki TAKATSU, Tokyo (JP); Tetsunori KOBAYASHI, Tokyo (JP); Shinya FUJIE, Tokyo (JP); Yoichi MATSUYAMA, Tokyo (JP)

(21) Appl. No.: 18/303,573

(22) Filed: Apr. 20, 2023

Related U.S. Application Data
(63) Continuation of application No. PCT/JP2021/038346, filed on Oct. 18, 2021.

(30) Foreign Application Priority Data
Oct. 21, 2020 (JP) 2020-176641

(51) Int. Cl. G10L 13/02

(52) U.S. Cl. CPC G10L 13/02

(57) ABSTRACT

A terminal includes: a scenario information reproduction means that sequentially reproduces units of scenario information based on reproduction instruction information, the scenario information including the units which are obtained by dividing a document into the units which are predetermined, the reproduction instruction information being set for each of the units in the scenario information; a reaction acquisition means that obtains a reaction of a user to a reproduced content; a reaction analysis means that analyzes a content of the reaction in accordance with the content of the reaction acquired and a timing of the reaction to the reproduced content; and a unit selection means that selects units for the reaction from the units of the scenario information in accordance with an analysis result, the scenario information reproduction means sequentially reproducing the units selected for the reaction.

### RELATED APPLICATIONS

The present application is a bypass continuation application of PCT Application No. PCT/JP2021/038346 filed Oct. 18, 2021, which is based on and claims the benefit of priority from the prior Japanese patent application 2020-176641 filed on Oct. 21, 2020. The entire contents of the above-captioned applications are incorporated herein by reference.

### TECHNICAL FIELD

The embodiments relate to an information reproduction program, an information reproduction method, an information processing device, and a data structure.

### BACKGROUND ART

As a conventional technique, there has been proposed an information reproduction program that summarizes document information and reproduces it by sound and responds to a reaction of a user by sound (see, for example, Patent Literature 1).

The information reproduction program disclosed in the Non Patent Literature 1 reproduces information called main plan which is prepared in advance and is created by summarizing document information such as news articles, and reproduces information called subplan which is for supplementing the main plan and is created based on a reaction prediction of a user in the context of the main plan. The information reproduction program first reproduces the main plan to transmit the information to the user, and then, in the case of receiving a reaction of the user to the main plan, reproduces the subplan in accordance with a content of the reaction to answer a question, make a supplementary explanation, or responds by repeating the content of the reaction. After the response by the subplan, the information reproduction program reproduces the main plan again, transmits the information to the user, and responds appropriately to the reaction of the user.

### CITATION LIST

### Non Patent Literature

Non Patent Literature 1: Hiroaki Takatsu, Ishin Fukuoka, Shinya Fujie, Yoshihiko Hayashi, Tetsunori Kobayashi, “A Spoken Dialogue System for Enabling Information Behavior of Various Intention Levels”, Journal of the Japanese Society for Artificial Intelligence, 33 (1), p. DSH-C 1-24, 2018

### SUMMARY OF INVENTION

### Technical Problem

According to the above-described information reproduction program, the main plan is reproduced to transmit information to the user and the subplan is used to respond to the reaction of the user to provide information with a priority based on an intention of an information provider (main plan) and to naturally provide information desired by the user as necessary (subplan), but there is a problem that in order to immediately respond to the user's response, the main plan and the subplan are generated in advance, and thus, the information generation cost for reproduction is not low.

An object of the embodiments is to provide an information reproduction program, an information reproduction method, an information processing device and a data structure for providing information with priorities based on an intention of a provider while lowering information generation cost and providing information desired by a user as necessary.

### Solution to Problem

In order to achieve the above-described object, one aspect of the embodiments provides the following information reproduction program, information reproduction method, information processing device and data structure.

Aspects of a first embodiment include an information reproduction program causing a computer to function as:
a reproduction means that sequentially reproduces units of scenario information based on reproduction instruction information, the scenario information including the units which are obtained by dividing a document into the units which are predetermined, the reproduction instruction information being set for each of the units in the scenario information;
a reaction acquisition means that acquires a reaction of a user to a reproduced content;
an analysis means that analyzes a content of the reaction in accordance with the content of the reaction acquired by the reaction acquisition means and a timing of the reaction to the reproduced content; and
a selection means that selects units for the reaction from the units of the scenario information in accordance with an analysis result of the analysis means,
the reproduction means
suspending reproduction of the scenario information based on the reproduction instruction information in accordance with the analysis result, and
resuming reproduction of the scenario information based on the reproduction instruction information after sequentially reproducing the units selected by the selection means for the reaction.

Aspects of a second embodiment include the information reproduction program according to the first embodiment, in which
when the reproduction means reproduces the units selected by the selection means for the reaction, the information reproduction program further causes the computer to function as a reproduction instruction information changing means that changes a set value of the reproduction instruction information of the scenario information based on the units which are reproduced, and
the reproduction means resumes reproduction of the scenario information based on the reproduction instruction information which is changed.

Aspects of a third embodiment include the information reproduction program according to the first embodiment, in which
the scenario information further includes additional information that is not reproduced based on the reproduction instruction information for each of the units, and
the selection means selects the additional information in accordance with the analysis result.

Aspects of a fourth embodiment include the information reproduction program according to the third embodiment, in which the selection means selects the units which have been reproduced with no priority over units that have not been reproduced.

Aspects of a fifth embodiment include the information reproduction program according to any one of the first to the fourth embodiments, further causing the computer to function as a reproduction instruction information changing means that changes the reproduction instruction information of the scenario information based on a preference of the user, which is obtained in advance.

Aspects of a sixth embodiment include the information reproduction program according to any one of the first to the fifth embodiments, further causing the computer to function as a reproduction instruction information changing means that changes the reproduction instruction information of the scenario information based on the reaction acquired by the reaction acquisition means prior to the reaction to the reproduced content of the scenario information.

Aspects of a seventh embodiment include the information reproduction program according to any one of the first to the sixth embodiments, in which the reproduction means reproduces information other than the scenario information in accordance with the analysis result of the analysis means.

Aspects of an eighth embodiment include the information reproduction program according to any one of the first to the seventh embodiments, in which the reproduction means performs at least one of a command response, a template response, a supplementary response, an open response, and a default response as a response other than the scenario information.

Aspects of a ninth embodiment include the information reproduction program according to any one of the first to the eighth embodiments, in which the reproduction means performs a reproduction control of the scenario information automatically, based on an operation of the user, or based on a position information of the user.

Aspects of a tenth embodiment include the information reproduction program according to any one of the first to the ninth embodiments, in which the reproduction means continues reproduction without suspending the scenario information based on the reproduction instruction information in accordance with the analysis result of the analysis means.

Aspects of an eleventh embodiment include an information reproduction method including:
a reproduction step of sequentially reproducing units of scenario information based on reproduction instruction information, the scenario information including the units which are obtained by dividing a document into the units which are predetermined, the reproduction instruction information being set for each of the units in the scenario information;
a reaction acquisition step of acquiring a reaction of a user to a reproduced content;
an analysis step of analyzing a content of the reaction in accordance with the content of the reaction acquired by the reaction acquisition step and a timing of the reaction to the reproduced content;
a selection step of selecting units for the reaction from the units of the scenario information in accordance with an analysis result of the analysis step; and
a response reproduction step of
suspending reproduction of the scenario information based on the reproduction instruction information, and
resuming reproduction of the scenario information based on the reproduction instruction information after sequentially reproducing the units selected by the selection means for the reaction.

Aspects of a twelfth embodiment include an information processing device including:
a reproduction means that sequentially reproduces units of scenario information based on reproduction instruction information, the scenario information including the units which are obtained by dividing a document into the units which are predetermined, the reproduction instruction information being set for each of the units in the scenario information;
a reaction acquisition means that acquires a reaction of a user to a reproduced content;
an analysis means that analyzes a content of the reaction in accordance with the content of the reaction acquired by the reaction acquisition means and a timing of the reaction to the reproduced content; and
a selection means that selects units for the reaction from the units of the scenario information in accordance with an analysis result of the analysis means,
the reproduction means
suspending reproduction of the scenario information based on the reproduction instruction information, and
resuming reproduction of the scenario information based on the reproduction instruction information after sequentially reproducing the units selected by the selection means for the reaction.

Aspects of a thirteenth embodiment include a data structure of scenario information including units which are obtained by dividing a document into the units which are predetermined, in which
an item and reproduction instruction information for the item are set for each of the units and the units of the scenario information are sequentially reproduced based on the reproduction instruction information, and
when a reaction of a user to a reproduced content of the units is acquired, a content of the reaction is analyzed in accordance with the content of the reaction of the user and a timing of the reaction to the reproduced content, and the units of the scenario information are selected and reproduced as a response to respond to the reaction in accordance with the analysis result.

Aspects of a fourteenth embodiment include the data structure according to the thirteenth embodiment, in which
after the units selected for the reaction are reproduced, the reproduction instruction information of the scenario information is changed based on the units which are reproduced, and reproduction of the scenario information is resumed based on the reproduction instruction information which is changed.

Aspects of a fifteenth embodiment include the data structure according to the first or the fourteenth embodiment, in which each of the units further includes additional information and the additional information is selected and reproduced as a response in accordance with the analysis result.

### Advantageous Effects of Invention

According to the embodiments, it is possible to provide information with priorities based on an intention of a provider while lowering information generation cost and provide information desired by a user as necessary.

### BRIEF DESCRIPTION OF DRAWINGS

FIG. 1 is a schematic diagram illustrating an example of a configuration of an information distribution system according to an embodiment.

FIG. 2 is a block diagram illustrating a configuration example of a terminal according to the embodiment.

FIG. 3 is a block diagram illustrating a configuration example of an information distribution server according to the embodiment.

FIG. 4 is a diagram for explaining an outline of an operation of generating scenario information.

FIG. 5 is a diagram for explaining an outline of an operation of dividing content information and an operation of generating scenario information.

FIG. 6 is a diagram illustrating a configuration example of scenario information in which reproduction instruction information is set.

FIG. 7 is a schematic diagram illustrating a reproduction operation example of scenario information.

FIG. 8 is a flowchart illustrating a reproduction operation example of scenario information.

FIG. 9 is a flowchart illustrating a reproduction operation example of scenario information.

FIG. 10 is a flowchart illustrating an operation example of reaction analysis.

FIG. 11 is a flowchart illustrating an operation example of unit selection.

### DESCRIPTION OF EMBODIMENTS

### Embodiment

### (Configuration of Information Distribution System)

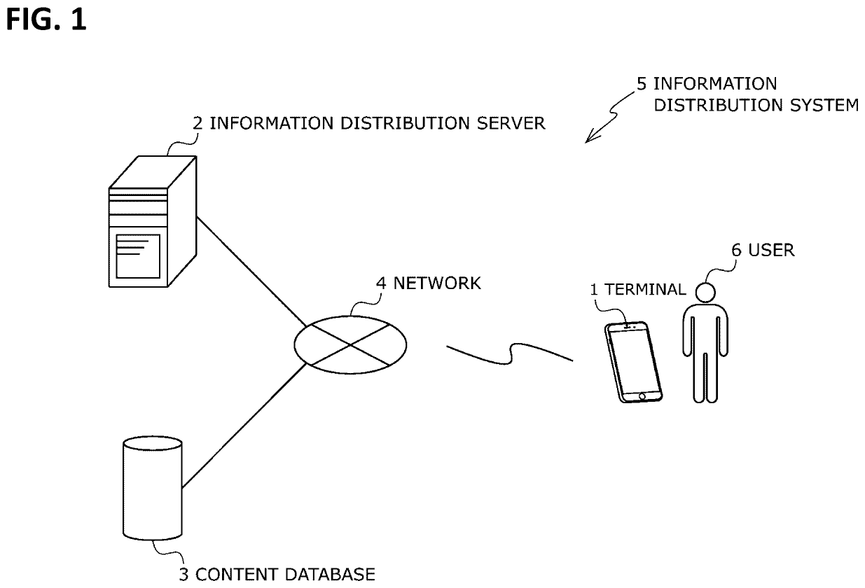

FIG. 1 is a schematic diagram illustrating an example of a configuration of an information distribution system according to an embodiment.

An information distribution system 5 is configured by connecting a terminal 1, an information distribution server 2, and a content database 3 via a network 4 in a manner that they can communicate with each other. The terminal 1 is operated by a user 6.

The terminal 1 is an information processing device such as a smartphone, a tablet terminal, or a PC (Personal Computer), and includes electronic components such as a CPU (Central Processing Unit) having a function for processing information and a flash memory in a main body. In addition to a portable device, the terminal 1 may be a built-in device such as a smart speaker or a network communication-compatible television. The terminal 1 may be a reproduction-only device including only necessary components as long as it is a device capable of reproducing scenario information (111) to be described later.

The information distribution server 2 is a server-type information processing device, operates in response to a request from the terminal 1 or an unillustrated external terminal, and includes electronic components such as the CPU having the function for processing information and the flash memory in the main body. The information distribution server 2 mainly acquires a content from the content database 3, generates scenario information (212) based on the content, and distributes the scenario information to the terminal 1.

The content database 3 stores document information such as a news article as the content, for example. New information is periodically added to the document information by the unillustrated external device.

The network 4 is a communication network capable of high-speed communication and is, for example, a wired or wireless communication network such as the Internet, an intranet, or a LAN (Local Area Network).

In the above configuration, as an example, the information distribution server 2 acquires the content information as the document information from the content database 3, divides the content information into predetermined units, and sets the reproduction instruction information for the units to generate the scenario information 212 summarizing the content to be reproduced. In addition, the information distribution server 2 distributes the scenario information 212 generated in response to the request from the terminal 1 to the terminal 1. Next, the terminal 1 receives the scenario information 212, reproduces the scenario information 111 based on the set reproduction instruction information, and transmits the summarized content to the user 6. When the user 6 hears the reproduced content and utters an acknowledgment, a doubt, a question or the like, the terminal 1 acquires the utterance as a reaction, analyzes the reaction, suspends the reproduction based on the reproduction instruction information of the scenario information 111, searches within the scenario information 111 for an appropriate response, and when necessary, searches outside the scenario information 111 to respond to the reaction. After the response, the terminal 1 resumes the reproduction based on the reproduction instruction information of the scenario information 111. It is assumed that the reproduction instruction information can be rewritten according to the content of the response as necessary. Hereinafter, the configuration will be described in more detail.

### (Configuration of Terminal)

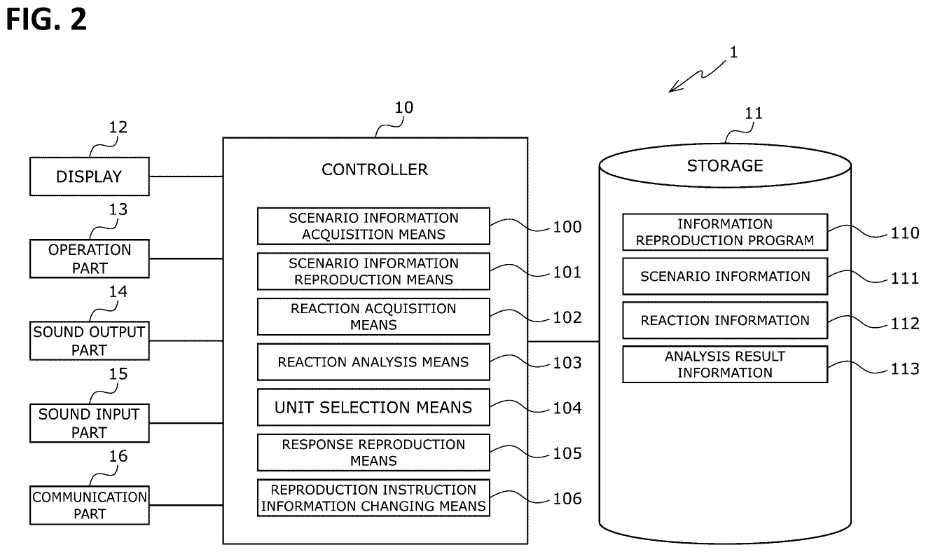

FIG. 2 is a block diagram illustrating a configuration example of the terminal 1 according to the embodiment.

The terminal 1 includes a controller 10 that is configured of a CPU and the like, controls each part and executes various programs, a storage 11 that is configured of a storage medium such as a flash memory and stores information, a display 12 such as an LCD (Liquid Crystal Display) that displays characters and images, an operation part 13 such as a touch panel, a button or a dial that receives an operation of the user 6 and outputs an operation signal, a sound output part 14 such as a speaker or a (priority or wireless) earphone connector that outputs sound, a sound input part 15 such as a microphone that receives input of sound, and a communication part 16 that communicates with the outside via the network 4.

The controller 10 functions as a scenario information acquisition means 100, a scenario information reproduction means 101, a reaction acquisition means 102, a reaction analysis means 103, a unit selection means 104, a response reproduction means 105, a reproduction instruction information changing means 106, and the like by executing an information reproduction program 110 to be described later.

The scenario information acquisition means 100 requests the information distribution server 2 to acquire the scenario information (212) to be described later via the communication part 16 and the network 4, acquires the scenario information 212, and stores the scenario information 212 as the scenario information 111 in the storage 11. A configuration example of the scenario information 111 will be described later.

The scenario information reproduction means 101 first reproduces the scenario information 111 based on the reproduction instruction information to be described later, and performs sound output control in accordance with the reproduced content from the sound output part 14. Although the embodiment will be described with respect to information mainly including sound information as the scenario information 111, the information is not limited to sound information and may be video information, text information, image information, or information obtained by combining these.

The reaction acquisition means 102 acquires a sound mainly uttered by the user 6 as a reaction to the reproduced content of the scenario information 111 via the sound input part 15, and stores the sound as a reaction information 112 in the storage 11. In addition, although the embodiment will be described mainly with respect to sound information as a reaction acquired by the reaction acquisition means 102, the reaction is not limited to sound information as long as it is a reaction of the user 6, and may be an operation content on the operation part 13 of the user 6, or video information obtained by capturing a facial expression or a gesture, etc. of the user 6.

The reaction analysis means 103 analyzes the reaction information 112 acquired by the reaction acquisition means 102, and stores the analysis result together with the reaction type as the analysis result information 113 in the storage 11. The analysis operation of the reaction of the reaction analysis means 103 will be described later.

The unit selection means 104 selects units constituting the scenario information 111 based on the analysis result information 113 when a scenario response to be described later is required. The unit selection operation of the unit selection means 104 will be described later.

The response reproduction means 105 reproduces the units selected by the unit selection means 104 as a response to the reaction of the user 6 in the case of a scenario response, and reproduces other contents to be described later as a response to the reaction of the user 6 in the case where another type of response is required. The response reproduction means 105 does not respond when the reaction analysis means 103 determines that a response is unnecessary.

When the response reproduction means 105 responds, the reproduction instruction information changing means 106 changes the reproduction instruction information of the scenario information 111 based on the content of the response (the units selected by the unit selection means 104). Content of the change will be described later. The reproduction instruction information changing means 106 may collate the reaction information 112 and the analysis result information 113 for the scenario information 111 which is reproduced in the past with information such as the genre, the content, and the amount of information of the scenario information 111 which is not reproduced and change the reproduction instruction information 2120 in accordance with the hobby and preference of the user.

The storage 11 stores the information reproduction program 110, the scenario information 111, the reaction information 112, the analysis result information 113, and the like that cause the controller 10 to operate as the above-described means 100 to 106.

### (Configuration of Information Distribution Server)

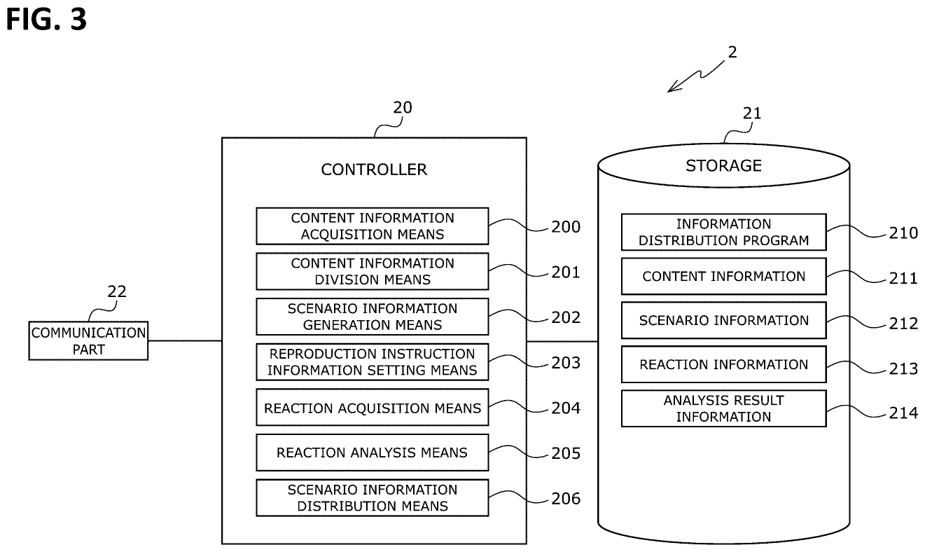

FIG. 3 is a block diagram illustrating a configuration example of the information distribution server 2 according to the embodiment.

The information distribution server 2 includes a controller 20 that is configured of a CPU and the like, executes various programs and controls each part, a storage 21 that is configured of a storage medium such as a flash memory and stores information, and a communication part 22 that communicates with the outside via the network 4.

The controller 20 functions as a content information acquisition means 200, a content information division means 201, a scenario information generation means 202, a reproduction instruction information setting means 203, a reaction acquisition means 204, a reaction analysis means 205, a scenario information distribution means 206, and the like by executing an information distribution program 210 to be described later.

The content information acquisition means 200 requests the content database 3 to acquire the content information via the communication part 22 and the network 4, acquires the content information, and stores the content information as the content information 211 in the storage 11. A configuration example of the content information 211 will be described later.

The content information division means 201 divides the content information 211, which is document information, into predetermined units such as sentences, clauses, and words. When the content information 211 is content such as video, sound, and image other than text, the content is divided into units (chapters, scenes, pictures, frames, etc. in the case of video, tracks, bars, etc. in the case of sound, and image ranges, pixels, etc. in the case of image) which are respectively suitable for the type of content.

The scenario information generation means 202 imparts supplementary information (reproduction instruction information) such as presence or absence of reproduction and reproduction order to the units divided by the content information division means 201, and changes the expression to, for example, a colloquial style as necessary, etc. to generate the scenario information 212.

The scenario information generation means 202 can automatically further impart additional information to divided units, and can also receive and impart additional information such as a definition edited by an operator using an authoring tool (not illustrated).

In addition, an example will be described in which the scenario information generation means 202 generates a sound file obtained by converting a set of units (speech section) into sound information and has link information for the sound file as an item of the scenario information 212, but the scenario information 212 may not have a link of a sound file as an item, may hold a set of units as text information, and may reproduce sound from the text information in a reproduction device.

Although an example in which the scenario information generation means 202 generates one piece of the scenario information 212 from one piece of the content information 211 will be described below, the scenario information generation means 202 may generate one piece of the scenario information 212 from a plurality of pieces of the content information 211 or may generate a plurality of pieces of the scenario information 212 from one piece of the content information 211.

The reproduction instruction information setting means 203 sets reproduction instruction information such as presence or absence of reproduction and reproduction order for each unit or each of a plurality of units with respect to the supplementary information of the scenario information 212 in order to summarize the content of the content information 211 based on a predetermined criterion. The predetermined criterion may be importance, length of reproduction time, interest, degree of understanding, number of sentences, number of characters, and a combination thereof determined on the service provider side, or may be the above-described criterion selected by the user 6 and the hobby or preference obtained by a questionnaire or the like, and the criterion may be one or more.

The reaction acquisition means 204 acquires the reaction information 112 of the user 6 for the scenario information 111 during the reproduction or the reaction information 112 of the user 6 for the past reproduction from the terminal 1, and stores the acquired reaction information 112 in the storage 21 as the reaction information 213.

The reaction analysis means 205 analyzes the reaction acquired by the reaction acquisition means 204 and stores the analysis result as the analysis result information 214 in the storage 21.

The scenario information distribution means 206 distributes the scenario information 212 to the terminal 1.

The storage 21 stores the information distribution program 210 that causes the controller 20 to operate as the above-described means 200 to 206, and stores the content information 211, the scenario information 212, the reaction information 213, the analysis result information 214, and the like.

### (Operation of Information Processing Device)

Next, the operation of the present embodiment will be described in terms of (1) scenario information generation operation, (2) scenario information reproduction operation, and (3) other operations.

### (1) Scenario Information Generation Operation

First, the content information acquisition means 200 of the information distribution server 2 acquires content information from the content database 3 in order to generate the scenario information 212 to be distributed to the terminal 1. The acquired information is stored in the storage 21 as the content information 211. The content information 211 is, for example, document information constituted of text, the content thereof including news, travel guide, English conversation, and the like.

Next, the scenario information 212 is generated from the content information 211 by the division operation of the content information division means 201 and the generation operation of the scenario information generation means 202.

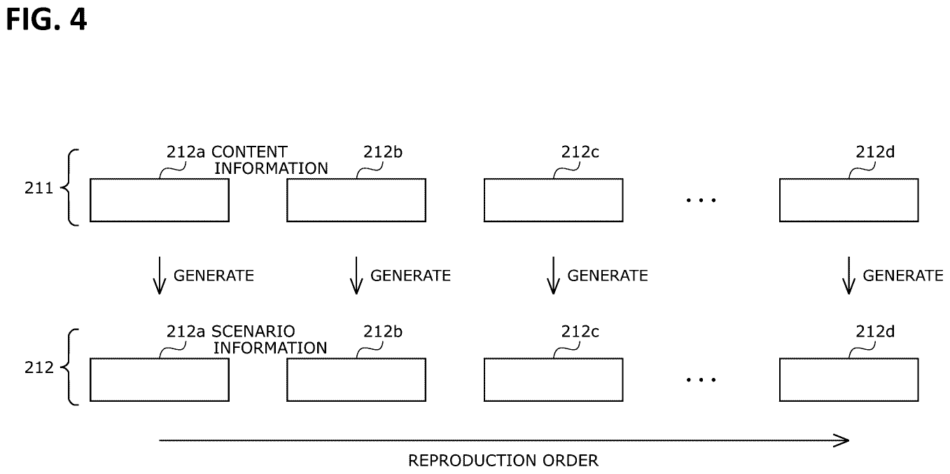

FIG. 4 is a diagram for explaining an outline of an operation of generating the scenario information 212.

By the division operation and the generation operation, scenario information 212a, 212b, 212c, . . . 212d are generated from content information 211a, 211b, 211c, . . . 211d, respectively. Hereinafter, the division operation and the generation operation will be respectively described.

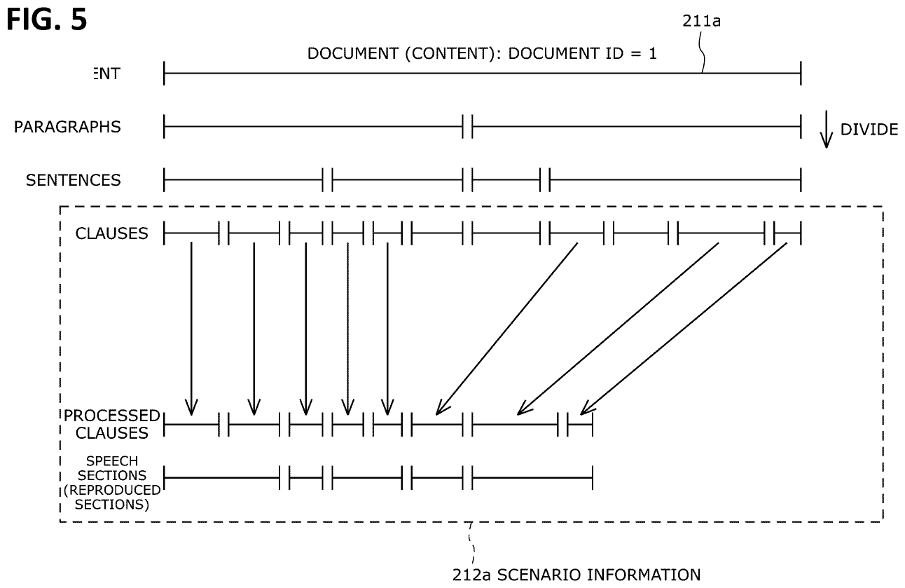

FIG. 5 is a diagram for explaining an outline of the operation of dividing the content information 211 and the operation of generating the scenario information 212.

First, the content information division means 201 divides the content information 211a into, for example, predetermined units such as paragraphs, sentences, clauses, and words.

Next, the scenario information generation means 202 imparts supplementary information of items such as presence or absence of reproduction and reproduction order to the units divided by the content information division means 201 to generate the scenario information 212a. The scenario information generation means 202 converts the text of each unit into a colloquial style, and makes the text converted into the colloquial style into a sound file and record a link for accessing the sound file in the scenario information 212a.

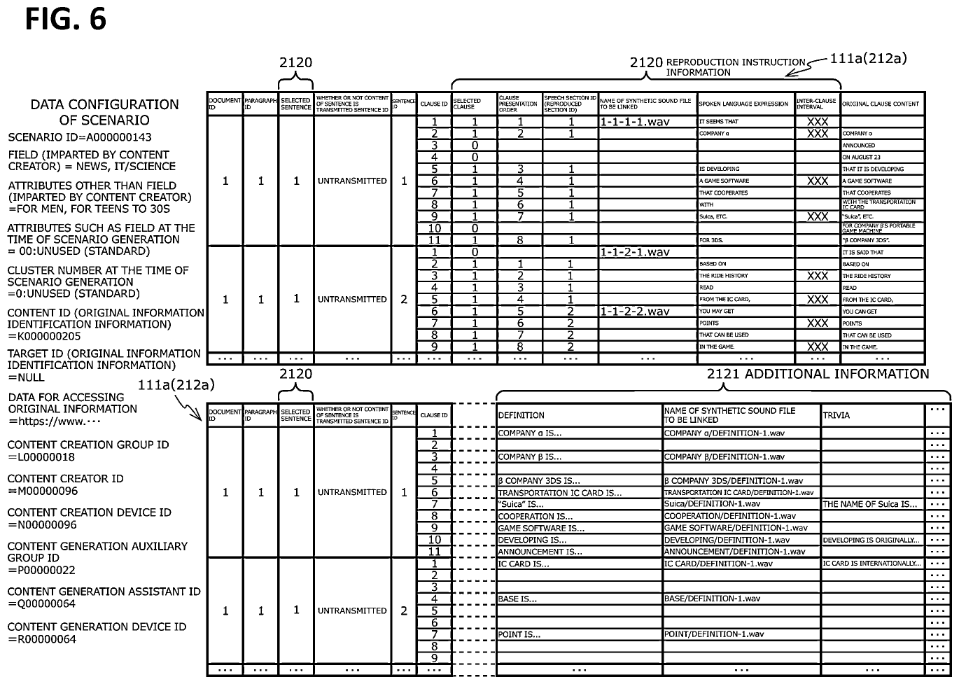

Specifically, what is first generated by the scenario information generation means 202 is the scenario information 212 illustrated in FIG. 6, in which the reproduction instruction information 2120 such as presence or absence of reproduction and reproduction order is not set, and the generation of the scenario information 212 is completed when the reproduction instruction information 2120 is set by the reproduction instruction information setting means 203. The summarized content is reproduced by reproducing the units in which the selected clause of the reproduction instruction information 2120 is set to “1” in a clause presentation order, and the units in which the selected clause of the reproduction instruction information 2120 is not set are used for responding to the reaction of the user 6 to the reproduced content, and are also used for later reproduction by changing the reproduction instruction information 2120.

Further, in order to respond to the reaction of the user 6, the scenario information generation means 202 acquires information from an unillustrated external information database or an unillustrated information provision site on the Internet as necessary with respect to units including a proper noun, a term considered to have a low degree of recognition, or the like, and adds information such as a definition of the proper noun, the term, or the like or trivia.

FIG. 6 is a diagram illustrating a configuration example of the scenario information 212 in which the reproduction instruction information 2120 is set.

The scenario information 212a includes a document ID for identifying the document information (the content information 211), a “paragraph ID” for identifying a paragraph in the document, a “selected sentence” in which “1” is imparted to a sentence selected to be transmitted, a “whether or not the content of the sentence is transmitted” indicating whether or not the sentence is transmitted to the user by reproduction, a “sentence ID” for identifying a sentence, a “clause ID” for identifying a clause, a “selected clause” in which “1” is imparted to the clause selected to be reproduced, a “clause presentation order” indicating the order of reproduction, a “speech section ID” for identifying the speech section, a “name of synthetic sound file to be linked” for linking to sound information of the speech section ID, a “spoken language expression” as a result of converting the content of the original clause into a colloquial style, an “inter-clause interval” indicating an interval provided between the current clause and the next clause, and an “original clause content” indicating the content of the clause before conversion into the spoken language expression. Here, the selected sentence is set by the reproduction instruction information setting means 203 and is imparted based on a predetermined criterion. For example, when the criterion is importance, a sentence including important information (a sentence determined to be important according to the predetermined criterion) is “1” and a sentence not including important information is “0”. When the criterion is the interest of user, a sentence including information determined to be interesting (a sentence determined to be interesting according to the predetermined criterion) is “1”, and a sentence not including information determined to be interesting is “0”. Further, the criterion may be another criterion, or may be a combination of importance, interest level, and another criterion.

Among the above items, the values of the selected clause, the clause presentation order, the speech section ID, the name of synthetic sound file to be linked, the spoken language expression, and the inter-clause interval are set by the scenario information generation means 202 and are referred to as the reproduction instruction information 2120, but the reproduction instruction information 2120 may further include other items such as selected sentence or may be a part of items selected from the above items.

The scenario information 212a also has additional information 2121 which is added as necessary. The additional information 2121 includes a “definition” indicating the definition of the content of a clause, a “name of a synthetic sound file of a definition to be linked” for linking to sound information indicating the content of the definition, a “trivia” indicating trivia, bits of knowledge, or the like related to the content of the clause, and other information. In addition, a response history (not illustrated) is recorded for each of these definitions and the like as necessary. That is, the response history is recorded separately from the item “whether or not the content of the sentence is transmitted” (transmission history of units) of the scenario information 212a.

### (2) Scenario Information Reproduction Operation

Next, the scenario information acquisition means 100 of the terminal 1 requests the information distribution server 2 to acquire the scenario information 212 via the communication part 16 and the network 4 in response to an operation of the user 6 or periodically.

Upon receiving the acquisition request for the scenario information 212, the scenario information distribution means 206 of the information distribution server 2 distributes the scenario information 212 to the terminal 1.

The scenario information acquisition means 100 of the terminal 1 acquires the scenario information 212 and stores the scenario information 212 as the scenario information 111 in the storage 11.

Next, the scenario information reproduction means 101 of the terminal 1 reproduces the scenario information 111 in response to an operation of the user 6 or in response to another trigger such as position information of the terminal 1, sound input to the sound input part 15, or information input via the communication part 16.

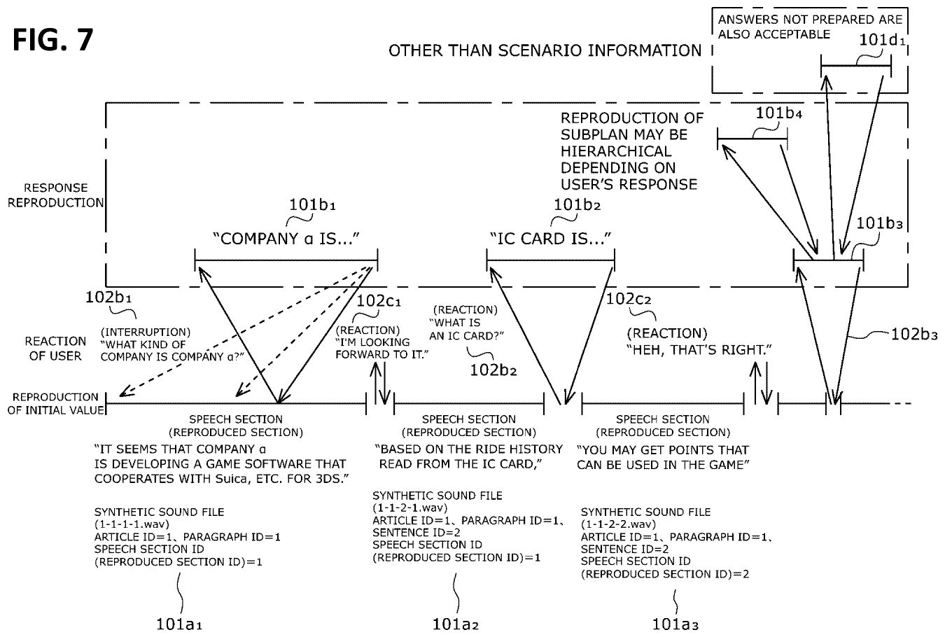

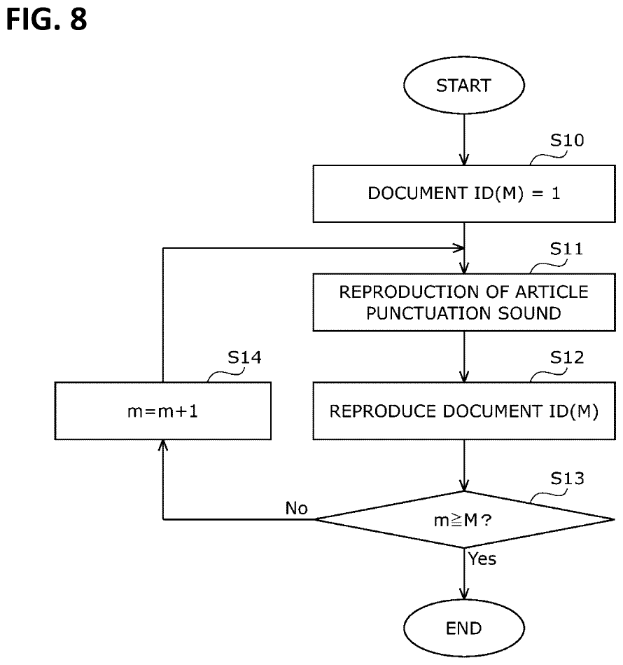

FIG. 7 is a schematic diagram illustrating a reproduction operation example of the scenario information 111. FIG. 8 is a flowchart illustrating a reproduction operation example of the scenario information 111.

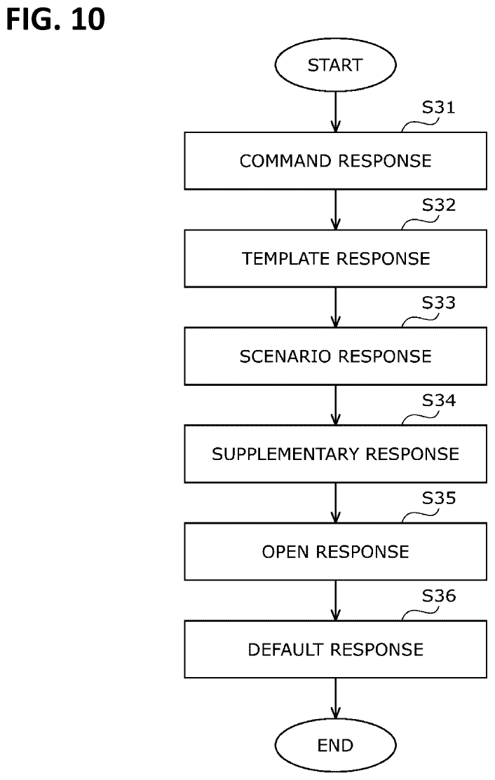

The scenario information reproduction means 101 first sets m=1 to reproduce the scenario information 111a of the document ID=1 among the plurality of pieces of scenario information 111a, 111b, 111c . . . (S10), and, for example, reproduces the scenario information 111a whose document ID is the m-th (m=1) (S12) after reproducing a punctuation sound such as an electronic sound or a melody (S11) to indicate to the user 6 that a new content starts. The scenario information reproduction means 101 reproduces the scenario information 111a for each speech section ID based on the reproduction instruction information 2120 (reproduction order, presence or absence of reproduction), and performs sound output control according to the reproduced content from the sound output part 14. The above-described steps S11 and S12 are repeated until the last document ID=M (S13, S14). When an operation for stopping the reproduction is performed by the user 6, the reproduction is also stopped by a command response (FIG. 10, S31) to be described later before the document ID=M. Similarly, when the user 6 performs document forwarding or rewinding operations such as “next piece of news”, “previous piece of news”, or “from the beginning”, the scenario information 111 to be reproduced is also switched to “m=m+1”, “m=m−1”, or “m=m” during reproduction of the m-th document. Further, the scenario information 111 to be reproduced may be switched by jumping not only to the adjacent document but also to a specific document.

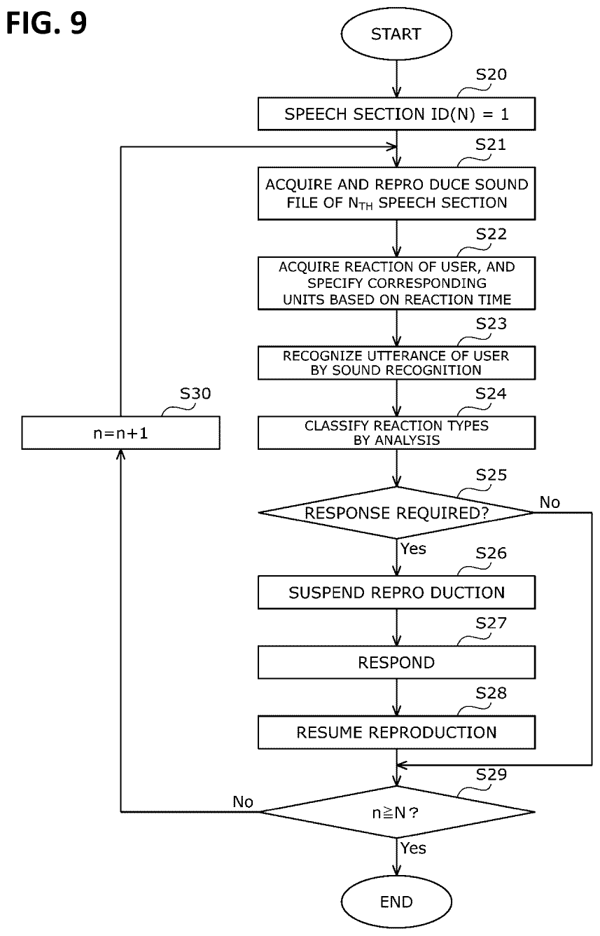

Further, when there is a reaction by the utterance of the user 6 during the reproduction of the scenario information 111 of the m-th document ID (step S12), a response is made to the reaction as illustrated in FIG. 9 below.

FIG. 9 is a flowchart illustrating a reproduction operation example of the scenario information 111.

The scenario information reproduction means 101 first sets n=1 in order to reproduce the speech section of ID=1 among the plurality of speech sections (S20), acquires the linked synthetic sound file corresponding to the speech section ID from the scenario information 111, and reproduces the file (S21). Further, when the reproduction is completed, the scenario information reproduction means 101 rewrites the item “whether or not the content of the sentence is transmitted” of the scenario information 111 from “untransmitted” at the start of the operation to “transmitted”.

As shown in FIG. 7, the synthetic sound file reproduced in step S21 is, for example, “1-1-1-1.wav”, and a content 101a1 such as “company α is likely to develop a game software for 3DS in cooperation with Suica, etc.” is reproduced. As illustrated in steps S24 and S25 to be described later, the content 101a2 of the synthetic sound file “1-1-2-1.wav” and the content 101a3 of the synthetic sound file “1-1-2-2.wav” are sequentially reproduced with an interval interposed therebetween.

The user 6 listens to the reproduced sound, and when there is an acknowledgment, a question, a doubt, an operation instruction, or the like in the middle of the speech section being reproduced, the user 6 utters it as an interrupt reaction (user reactions 102b1 and 102b3 illustrated in FIG. 7). When there is an acknowledgment, a question, a doubt, an operation instruction, or the like at an interval between speech sections, the user 6 utters it as a reaction (user reactions 102b2, 102c1, 102c2 illustrated in FIG. 7). The reaction is input to the reaction analysis means 103 by the sound input part 15 of the terminal 1.

The reaction acquisition means 102 of the terminal 1 acquires a reaction to the reproduced content of the scenario information 111 via the sound input part 15, and stores the reaction as the reaction information 112 in the storage 11. Further, the reaction acquisition means 102 collates the time when the user reacts with the reproduction time of the speech section, specifies a unit in the speech section corresponding to the timing of the reaction, and writes the unit into the reaction information 112 (S22).

The reaction analysis means 103 of the terminal 1 recognizes the utterance of the user by sound recognition in the reaction information 112 acquired by the reaction acquisition means 102 (S23), analyzes the content of the utterance which is the sound recognition result and the content of the reaction based on the timing of the reaction, classifies the content into a predetermined reaction type as the analysis result, and stores the classification result as the analysis result information 113 in the storage 11 (S24).

Next, when the classification result of the analysis result information 113 indicates that a response is necessary (S25; Yes), the scenario information reproduction means 101 suspends the reproduction (S26), and the response reproduction means 105 responds based on the classification result of the analysis result information 113 (S27, response reproductions 101b1, 101b2, 101b3 illustrated in FIG. 7). A response may be made to the response reproduction 101b3 or 101d1 in addition to a reproduction based on reproduction instruction information such as a response reproduction 101b4.

The term “suspend” as used herein includes the case that when the scenario information 111 is being reproduced, the scenario information reproduction means 101 also pauses the reproduction in the middle of the speech section as necessary. Further, the information reproduction means 101 responds after the suspension (S27) and then resumes the reproduction (S28). When it is a timing at an interval after the reproduction of the speech section being currently reproduced is completed, since the reproduction of the speech section is completed, a pause is not required, but the completion of the response (S27) is waited without performing the reproduction of the next speech section, and the waiting is also included in “suspension”. In addition, it is desirable that the scenario information 111 whose reproduction is resumed is obtained by rewriting the reproduction instruction information 2120 in accordance with the content reproduced by the response reproduction means 105, and the content of rewriting will be described later.

When the classification result of the analysis result information 113 indicates that a response is not necessary (S25; No), the scenario information reproduction means 101 continues the reproduction of the speech section without making a response.

The above-described steps S21 to S28 are repeated until the last speech section ID=N (S29, S30). When an operation for stopping the reproduction is performed by the user 6, the reproduction is also stopped by a command response (FIG. 10, S31) to be described later before the speech section ID=N. Similarly, when the user 6 performs speech section forwarding or rewinding operations such as “next sentence”, “previous sentence”, or “say once again”, the speech section to be reproduced is also switched to “n=n+1”, “n=n−1”, or “n=n” during reproduction of the n-th document. Further, the speech section to be reproduced may be switched by jumping not only to the adjacent speech section but also to a specific speech section.

When a response is made to the reaction of the user during the reproduction of the sound of the n-th speech section ID (step S27), the response is made with appropriate contents according to the classification result as described below.

FIG. 10 is a flowchart illustrating an operation example of reaction analysis.

Next, the response reproduction means 105 responds with any one of command response, template response, scenario response, supplementary response, open response, and default response based on the classification result of the analysis result information 113 (S31 to S36). At this time, when any one of the responses is finished, the process transitions to END (not illustrated). The analysis and classification of the reaction contents in step S24 may be performed in the order of S31 to S36 described below according to the priorities of the operations.

Here, the command response (S31) is a response in a case where the reaction type is an operation command such as “wait for a while”, “go back”, or “go to the next article”, and returns a response indicating that the reaction is received and performs an operation in accordance with the operation command.

The template response (S32) is a response in a case where a reaction matches a predetermined rule, and returns a response according to the rule. For example, in a case where an adjective is included in a reaction, a response is made to a reaction of “interesting” by repeating the same expression such as “interesting, isn't it”. When the reaction is an adjective accompanied by confirmation, a response such as “I think . . . ” is made. In addition, when the reaction is self-disclosure, the response is “I see”. In addition, in a case where the reaction is an opinion such as “I think . . . ”, the response is “Mm, you bet”. In addition, in a case where the reaction is an opinion such as “should . . . ”, the response is “Yes, I think so”. In addition, in a case where the reaction is an opinion such as “should not . . . ”, the response is “Well, ok, that's right”.

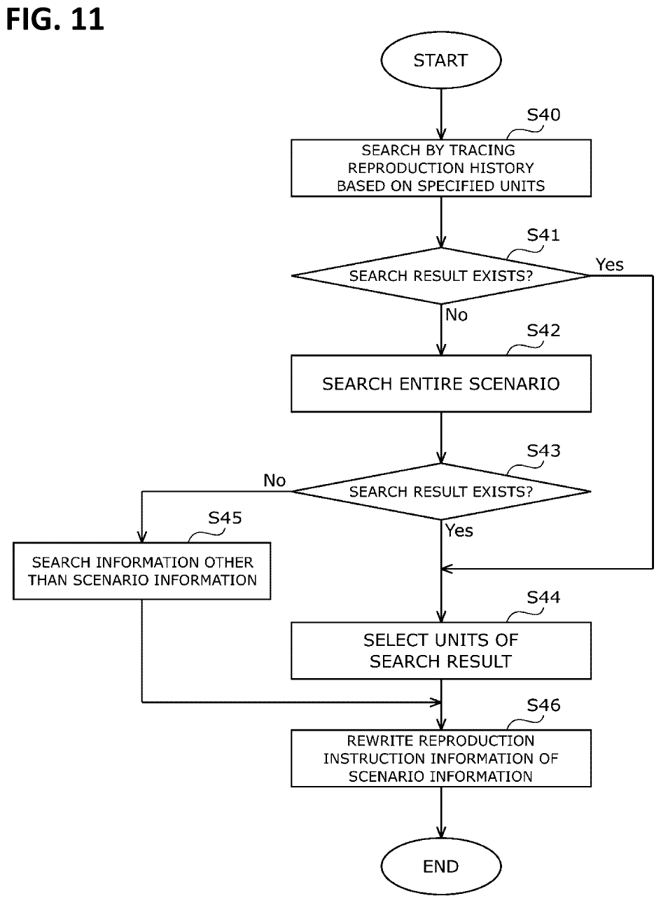

The scenario response (S33) is a response performed using the scenario information 111, and will be described in detail with reference to FIG. 11 below. The response reproduction means 105 reproduces the units selected by the unit selection means 104 in FIG. 11 as a response to the reaction of the user 6.

The supplementary response (S34) includes response based on similarity, response by information addition, response by noun repetition, response by error handling, and the like.

As the response based on similarity, a sentence having the highest similarity among sentences in which the similarity between the content word included in the reaction and the sentence in the scenario information 111 is equal to or more than a predetermined threshold is responded. In addition, when the reaction includes an adjective that indicates interest in the sentence being reproduced (for example, “interesting, huh”) or when the reaction is a word that prompts reproduction such as “so” or “then”, the response by information addition is made by adding another sentence in the same paragraph as the sentence being reproduced and reproducing the sentence.

In addition, in a case where the reaction is a noun included in the sentence being reproduced, when the noun is “˜”, the response by noun repetition is “so, ˜”. In addition, when the reaction is a misstatement of a term of the sentence being reproduced, the response by error handling is made by the repetition or definition explanation of the term. For example, a response of “glucorafasatin” is made to a reaction of “Glucola” or “Glucola, what?”, and a response of “Shinko means . . . ” is made to a reaction of “Progress (shinko)?”.

The open response (S35) is a response to a question in which information not included in the scenario information 111 is an answer, and the response is made by searching for the answer using an external service.

The default response (S36) responds with “I'm not sure about that” when the reaction is a question or confirmation but cannot be answered. In addition, when the reaction is not a question or a confirmation and none of the above-described responses is made, a response is made with an acknowledgment “un-huh”.

When a scenario response is made in the above-described step S33, the scenario information 111 is used to determine the response content as follows.

FIG. 11 is a flowchart illustrating an operation example of unit selection.

The unit selection means 104 searches the units constituting the scenario information 111 for a unit to be an answer to the reaction of the user 6 based on the unit, which is specified in step S22 with respect to the reaction on the basis of the analysis result information 113 (S40). The search is performed among the reproduced units by following the history (not illustrated) of the units (in which the reproduction instruction information 2120 is set) reproduced by the scenario information reproduction means 101.

For example, when there is a reaction “What is the company α?” from the user, as a first pattern, definition related to “company α” in the additional information is searched for by tracing back the reproduction history from the units (clauses or the like) reproduced by the scenario information reproduction means 101 at the time of the reaction.

As a second pattern, the reproduction history is traced back from the units (clauses or the like) reproduced by the scenario information reproduction means 101 at the time of the reaction to search for units including the explanation related to “company α” from among the units where the value of the selected clause is “0”.

When no search result is found in the above-described step S40 (S41; No), the unit selection means 104 searches the entire scenario information 111 (S42). This is because the information that should be responsive to the reaction may be included in the untransmitted units.

For example, when there is a reaction “What is the company α?” from the user, as a third pattern, the explanation related to “company α” included in the untransmitted units whose reproduction order is behind the units (clauses or the like) reproduced by the scenario information reproduction means 101 at the time of the reaction is searched for.

As a result of these controls, the additional information becomes a candidate for reproduction for the transmitted portion reproduced by the scenario information reproduction means 101 before the reaction of the user, and all the units of the scenario information 111 become candidates for reproduction for the untransmitted portion regardless of the presence or absence of the reproduction instruction of the reproduction instruction information, and thus, not only the added explanatory information (additional information) but also the divided document information itself can be used as a material of the answer, thereby contributing to realization of a natural response with high coverage at a low cost.

The unit selection means 104 selects the units which are the search result of the above-described steps S40 and S42 as the units to be responded (S44).

At the time of selection, it is determined whether or not the unit to be a candidate has already been reproduced based on the reproduction history or the history information of the additional information, and the reproduced units or the additional information is selected with no priority only when there is no other candidates. The reproduced units or the additional information may be excluded from the selection, and this case is also regarded as a kind of non-priority selection. On the other hand, in the case where the reaction of the user 6 has the content of requesting reproduced units or additional information such as “what is ˜?” or “please tell me again about ˜”, the reproduced units or the additional information may be selected.

When no search result is found in the above-described step S42 (S43; No), the unit selection means 104 searches an external information database or the like as an information source outside the scenario information 111 (S45).

The reproduction instruction information changing means 106 rewrites the selected clause and the presentation order of the scenario information 111 based on the units selected by the unit selection means 104 or based on the search result outside the scenario information 111 (S46). The rewriting of the selected clause and the presentation order is performed, for example, in a manner that the same content as the selected units is not redundantly transmitted, and in a manner that the transmission order of the selected units and the subsequent content is appropriate. In addition, the rewriting of the selected clause and the presentation order may be in a manner that the selection can be canceled in accordance with the priorities so as not to exceed the upper limit of the transmission time.

Specifically, the responses in the above-described steps S40 to S45 include, for example, the following reactions and responses.

When the reaction does not include a predicate, like in a manner of “who?”, the response, as an answer, is the subject included in the clause closest to the speech section being reproduced. Further, when the reaction indicates a noun, like in a manner of “who is it” or “what is it”, the response is made as an answer in consideration of the low appearance frequency and the named entity class.

In addition, when the reaction is to ask about a named entity, like in a manner of “when” or “who”, a response is made as an answer based on the result of extracting the named entity. In addition, when the reaction is a why-type question, like in a manner of “Why?”, the response, as an answer, is a reason expression which is extracted from the scenario information 111 by focusing on a clue word such as “because” or “since”. In addition, a discourse relation (“cause”, “result”, or the like) between distant sentences may be specified by discourse structure analysis, and a question such as a why-type may be answered based on the result.

In addition, when the reaction is to ask about the definition such as “what company is company α?”, a response is made with a definition or trivia as the answer by referring to the additional information 2121 of the scenario information 111. When the reaction includes information that is not included in the scenario information 111, it may be answered by searching an external information database as in the response reproduction 101d1 illustrated in FIG. 7.

In addition, in a case where the reaction requests a determination of truth such as “is it ˜?”, an answer is generated based on a result of implicit contradiction recognition as a response. For example, in a case where an answer can be made by matching based on a predicate term structure, an answer such as “Yes, it is ˜” or “No, it is not, it is ˜” is generated as a response. When an answer cannot be made by matching based on the predicate term structure, the coverage rate of the content words of the reaction to the target sentence is calculated, and when the coverage rate is equal to or greater than a predetermined first value, the answer is “yes”; when the coverage rate is smaller than the first value and equal to or greater than a predetermined second value, the answer is “Yes, probably”; and when the coverage rate is smaller than the second value, the answer is “Hmm, I don't know”.

In addition, when the reaction is to ask about a degree in a manner of “what+(counter word)”, an expression matching “(numeral)+(counter word)” is searched for in the scenario information 111 as a response.

### (3) Other Operations

The basic operations of the terminal 1 for acquiring and reproducing the scenario information 111 have been described above, and the terminal 1 may change the reproduction instruction information 2120 of the acquired scenario information 111 in accordance with the hobby and preference of the user 6 as described below.

The reproduction instruction information changing means 106 of the terminal 1 may collate the reaction information 112 and the analysis result information 113 which are generated based on a reaction to the scenario information 111 which is reproduced in the past with information such as the genre, the content, and the amount of information of the scenario information 111 which is not reproduced and change the reproduction instruction information 2120 in accordance with the hobby and preference of the user. The reproduction instruction information 2120 of the scenario information 111 being reproduced may be changed by the reproduction instruction information changing means 106 based on the reaction information 112 and the analysis result information 113 generated based on the reaction to the scenario information 111 being reproduced currently.

The change of the reproduction instruction information 2120 may be performed in the information distribution server 2 when the scenario information 212 is generated as described below.

First, the reaction acquisition means 204 of the information distribution server 2 acquires, from the terminal 1, the reaction information 112 generated based on a reaction to the scenario information 111 reproduced in the past, and stores the acquired reaction information 112 as the reaction information 213 in the storage 21.

The reaction analysis means 205 analyzes the reaction acquired by the reaction acquisition means 204 and stores the analysis result as the analysis result information 214 in the storage 21.

Next, the reproduction instruction information setting means 203 sets the reproduction instruction information 2120 based on the reaction information 213 and the analysis result information 214 in accordance with the hobby and preference of the user. The reproduction instruction information setting means 203 may conduct a questionnaire to the user 6 in advance and set the reproduction instruction information 2120 based on the obtained answer. Specifically, the interest level of the user 6 with respect to each sentence is estimated based on the profile feature amounts obtained by the questionnaire and the feature amounts of the sentences of the scenario information 212, and the reproduction instruction information 2120 is set using the interest level. The reproduction instruction information change using the questionnaire may be a change of the reproduction instruction information 2120 of the scenario information 111 at the terminal 1.

### Effects of Embodiment

According to the above-described embodiment, since the content information 211 is divided to generate the scenario information 212 in the information distribution server 2 and the reproduction instruction information is set in the scenario information 212 to summarize the content to be reproduced, it is not necessary to generate different pieces of the scenario information 212 depending on the importance or the like, and it is possible to provide information with priorities based on the intention of the provider while lowering the information generation cost as compared with a case where an answer is prepared in advance to respond to the reaction of the user, for example.

In addition, at the terminal 1, the scenario information 212 is acquired to reproduce the content based on the reproduction instruction information as the scenario information 111, a unit serving as an answer is searched for and selected from the scenario information 111 in response to the reaction of the user 6, and the selected unit is used to give the answer in response, and thus, it is possible to provide information desired by the user as necessary.

On the other hand, in the state-transition type prior art, it is necessary to assume a reaction of user in advance, specify an answer to the reaction by a determination based on branching, and further prepare an answer in advance, and in order to realize a system for information transmission such as news distribution which is one of the application targets of the embodiments, the cost and time required for preparing branch determinations and answers are enormous, and cannot be said to be suitable for practical uses.

In addition, since the reproduction instruction information of the scenario information 111 is changed after a response is made at the terminal 1, it is possible to optimize the order of the reproduced content and to prevent content repetition, etc. based on the reproduction instruction information in accordance with the content of the response.

In addition, when the scenario information 212 is generated in the information distribution server 2, the questionnaire and the past or current reaction information 213 are analyzed to set the reproduction instruction information based on the analysis result information 214, and thus, since there is no need to generate different pieces of the scenario information 111 for each user only because the reproduction instruction information differs, it is possible to reflect the hobby and preference of the user while lowering the information generation cost. Similarly, the reaction information 112 is analyzed before or during reproduction of the scenario information 111 to change the reproduction instruction information based on the analysis result information 113 at the terminal 1, and thus, it is possible to reflect the hobby and preference of the user while lowering the information generation cost.

### Other Embodiments

The present invention is not limited to the above-described embodiment, and various modifications can be made within the scope of not departing from the gist of the present invention.

In the above-described embodiment, the functions of the means 100 to 106 of the controller 10 and the functions of the means 200 to 206 of the controller 20 are realized by programs, but all or some of the means may be realized by hardware such as an ASIC. The program used in the above-described embodiment may be provided by being stored in a recording medium such as a CD-ROM. In addition, replacement, deletion, addition, and the like of the above-described steps described in the above-described embodiment are possible within the scope of not changing the gist of the present invention.

In addition, the functions of the means 100 to 106 of the controller 10 of the terminal 1 do not necessarily need to be realized on the terminal 1, and may be realized on the information distribution server 2 within the scope of not changing the gist of the present invention. Similarly, the functions of the means 200 to 206 of the controller 20 of the information distribution server 2 do not necessarily need to be realized on the information distribution server 2, and may be realized on the terminal 1 within the scope of not changing the gist of the present invention.

### INDUSTRIAL APPLICABILITY

To provide an information reproduction program, an information reproduction method, an information processing device and a data structure for providing information with priorities based on an intention of a provider while lowering information generation cost and providing information desired by a user as necessary.

### REFERENCE SIGNS LIST

1 Terminal
2 Information distribution server
3 Content database
4 Network
Information distribution system
6 User
Controller
11 Storage
12 Display
13 Operation part
14 Sound output part
Sound input part
16 Communication part
Controller
21 Storage
22 Communication part
100 Scenario information acquisition means
101 Scenario information reproduction means
102 Reaction acquisition means
103 Reaction analysis means
104 Unit selection means
105 Response reproduction means
106 Reproduction instruction information changing means
110 Information reproduction program
111 Scenario information
112 Reaction information
113 Analysis result information
200 Content information acquisition means
201 Content information division means
202 Scenario information generation means
203 Reproduction instruction information setting means
204 Reaction acquisition means
205 Reaction analysis means
206 Scenario information distribution means
210 Information distribution program
211 Content information
212 Scenario information
213 Reaction information
214 Analysis result information
2120 Reproduction instruction information
2121 Additional information

1. A non-transitory computer-readable medium containing executable instructions which when executed by one or more processors of a computer, causing the computer to perform operations comprising:
sequentially reproducing units in scenario information based on reproduction instruction information being set for each of the units, wherein the units are obtained by dividing a document based on a predetermined rule to form the scenario information;
acquiring a reaction of a user to reproduced units of scenario information;
analyzing a content of the reaction of the user in accordance with the content of the reaction of the user and a timing of the reaction of the user to the reproduced units in the scenario information; and
selecting units responding to the reaction of the user from the units in the scenario information in accordance with an analysis result,
suspending reproduction of the units in the scenario information based on the reproduction instruction information in accordance with the analysis result, and
resuming reproduction of the units in the scenario information based on the reproduction instruction information after sequentially reproducing the selected units in the scenario information responding to the reaction of the user.

2. The non-transitory computer-readable medium according to claim 1, the operations further comprising:
changing a set value of the reproduction instruction information based on the selected and reproduced units in the scenario information, and
resuming reproduction of the units in the scenario information based on the changed set value of the reproduction instruction information.

3. The non-transitory computer-readable medium according to claim 1, wherein
the scenario information further includes additional information that is not reproduced based on the reproduction instruction information being set for each of the units, and
the selection operation further comprising selecting the additional information in accordance with the analysis result.

4. The non-transitory computer-readable medium according to claim 3, wherein the selection operation further comprising selecting the units which have been reproduced without being prioritized over units that have not been reproduced.

5. The non-transitory computer-readable medium according to claim 1, the operations further comprising changing the reproduction instruction information being set for each of units in the scenario information based on a pre-acquired preference of the user.

6. The non-transitory computer-readable medium according to claim 1, the operations further comprising changing the reproduction instruction information being set for each of units in the scenario information based on a content of a past reaction of the user acquired prior to the reaction of the user.

7. The non-transitory computer-readable medium according to claim 1, wherein the reproduction operation further comprising reproducing information other than the units in the scenario information in accordance with the analysis result.

8. The non-transitory computer-readable medium according to claim 1, wherein the reproduction operation further comprising performing at least one of a command response, a template response, a supplementary response, an open response, and a default response.

9. The non-transitory computer-readable medium according to claim 1, wherein the reproduction operation further comprising controlling reproduction of units in the scenario information automatically, based on an operation of the user, or based on a position information of the user.

10. A non-transitory computer-readable medium containing executable instructions which when executed by one or more processors of a computer, causing the computer to perform operations comprising:
sequentially reproducing units in scenario information based on reproduction instruction information being set for each of the units, wherein the units are obtained by dividing a document based on a predetermined rule to form the scenario information;
acquiring a reaction of a user to reproduced units of scenario information;
analyzing a content of the reaction of the user in accordance with the content of the reaction of the user and a timing of the reaction of the user to the reproduced units in the scenario information;
continuing reproduction without suspending the reproduction of the units in the scenario information based on the reproduction instruction information in accordance with the analysis result.

11. An information reproduction method comprising:
a reproduction step of sequentially reproducing units of scenario information based on reproduction instruction information being set for each of the units, wherein the units are obtained by dividing a document based on a predetermined rule to form the scenario information;
a reaction acquisition step of acquiring a reaction of a user to a reproduced units of scenario information;
an analysis step of analyzing the content of the reaction of the user in accordance with the content of the reaction acquired in the reaction acquisition step and a timing of the reaction of the user to the reproduced content;
a selection step of selecting units corresponding to the reaction of the user from the units in the scenario information in accordance with a result of the analysis; and
a response reproduction step of
suspending reproduction of the units in the scenario information based on the reproduction instruction information, and
resuming reproduction of the units in the scenario information based on the reproduction instruction information after sequentially reproducing the selected units responding to the reaction of the user.

12. An information processing device comprising:
a non-transitory computer-readable medium containing executable instructions which when executed by one or more processors of a computer, causing the computer to perform operations comprising:
sequentially reproducing units in scenario information based on a reproduction instruction information being set for each of the units, wherein the units are obtained by dividing a document based on a predetermined rule to form the scenario information;
acquiring a reaction of user to a reproduced units of scenario information;
analyzing a content of the reaction of the user in accordance with the content of the reaction of the and a timing of the reaction of the user to the reproduced units in the scenario information; and
selecting units responding to the reaction of the user from the units in the scenario information in accordance with an analysis result,
suspending reproduction of the units in the scenario information based on the reproduction instruction information, and
resuming reproduction of the units in the scenario information based on the reproduction instruction information after sequentially reproducing the selected units in the scenario information responding to the reaction of the user.

13. A non-transitory computer-readable medium containing executable instructions and a data structure of scenario information which when executed by one or more processors of a computer, causing the computer to perform a method to reproduce information, the data structure comprising:
units which are obtained by dividing a document based on a predetermined rule, wherein
an item and reproduction instruction information for the item are set for each of the units and the units of the scenario information are sequentially reproduced based on the reproduction instruction information, and
when a reaction of a user to the reproduced units of the scenario information is acquired, a content of the reaction of the user is analyzed in accordance with the content of the reaction of the user and a timing of the reaction to the reproduced units of the scenario information, and the units in the scenario information are selected and reproduced as a response to the reaction of the user in accordance with the analysis result.

14. The non-transitory computer-readable medium according to claim 13, wherein
after the units selected for the reaction of the user are reproduced, the reproduction instruction information being set for each in units of the scenario information is changed based on the reproduced units, and
reproduction of units in the scenario information is resumed based on the changed reproduction instruction information.

15. The non-transitory computer-readable medium according to claim 13, wherein each of the units further includes additional information and the additional information is selected and reproduced as the response in accordance with the analysis result.
